(19) United States
(12) Patent Application Publication
(10) Pub. No.: US 2007/0229248 A1
(43) Pub. Date: Oct. 4, 2007

(54) DAMAGE DOSING MONITORING SYSTEM

(75) Inventors: Clive Alistair MOTT, Aldermaston (GB); Andrew HALFPENNY, Sutton-in-Ashfield (GB)

Correspondence Address: LAW OFFICES OF WILLIAM H. HOLT, 12311 HARBOR DRIVE, WOODBRIDGE, VA, 22192, US

(73) Assignee: NCODE INTERNATIONAL LIMITED, Rotherham (GB)

(21) Appl. No.: 11/687,517

(22) Filed: Mar. 16, 2007

(30) Foreign Application Priority Data
Mar. 16, 2006 (GB) 06 05188.2

(51) Int. Cl. G08B 19/00; G08B 13/14; B60R 25/10; B60Q 1/00

(52) U.S. Cl. 340/522; 340/572.1; 340/436; 340/426.24

(57) ABSTRACT

An electronic tag is fixed on to a mechanical or electronic item or system, the electronic tag comprising at least one sensor such as an accelerometer to monitor the load in the item, a calculating means to receive signals from each sensor and to calculate the resulting damage to the item or to any other item attached to it, a memory to record data representing the resulting damage, and means to enable the recorded data to be downloaded. The tag calculates the damage caused by the accumulated vibrations and fluctuating loads that the item has been subjected to over its entire life (since the tag was attached), and this information remains stored in the tag even if the item itself is removed, stored, or used again.

This invention relates to a monitor and associated calculation methodology for monitoring and comparing damage and relative damage to a mechanical or electronic system through its life, and to a method for monitoring damage and assessing relative consumed life to the mechanical or electronic system or to any mechanical or electronic item attached to it by means of such a monitor and associated calculation methodology.

The use of strain gauges or accelerometers attached to mechanical or electronic items to monitor the vibration intensity that items are subjected to is well-known. However, during use of a mechanical or electronic item it will typically be subjected to varying vibration environments. For example a component of a vehicle suspension will be subjected to vibrations of varying amplitudes during movement of the vehicle, the amplitude depending on the characteristics of the road surface; a component forming part of an oil rig standing on the seabed will be subjected to vibrations of varying amplitudes caused by waves on the sea, and the amplitude of these vibrations will depend on how rough the sea is; an electronic system in a vehicle will be subject to varying vibrations and shocks that will depend on the physical usage of vehicle over various road types or mission profiles. The resulting damage to the item depends on the cumulative effect of all the induced vibrations and strains over the entire lifetime of the item. It would be desirable to be able to estimate the remaining lifetime or relative consumed life, of either a single mechanical or electronic item, or a group of items, before they are likely to suffer fatigue-induced failure, and this clearly depends upon the damage that they have suffered.

According to the present invention there is provided an electronic tag to be fixed on to or near to a mechanical or electronic system, the electronic tag comprising at least one sensor in the form of an accelerometer or strain gauge, a calculating means to receive signals from each sensor and to calculate the resulting damage, a memory to record data representing the resulting and relative damage, and means to enable the recorded data to be read.

Such an electronic tag evidently will require a source of energy, and this may be provided by a battery. The tag may incorporate an electricity generator, for example a vibration-driven generator or a solar panel, to recharge the battery, or the battery may be replaced at intervals, or may be recharged by an external charger at intervals. Reading of the data may involve making direct electrical contact to an external data reader, but more preferably it is read by downloading means operating in a non-contact manner. For example the data may be downloaded by radio signals, the tag incorporating an aerial, in an analogous manner to a radio-frequency identification tag (RFID tag). Such a tag, when activated by receipt of a radio signal of its operating frequency, transmits the data with which it has been encoded. The data would be downloaded to an external transmitter/receiver unit.

Alternatively the tag itself may be a simpler device, just consisting of an accelerometer or load sensor, the tag being attached by a wire to a processing unit, this unit powering one or more tags and analysing the data from the tags.

Preferably the transmitter/receiver unit (and the aerial within the tag) operate in the UHF or microwave frequency range. Suitable frequencies would be therefore in the range 860 MHz-930 MHz (UHF) or 2.45 GHz (microwave). Such high frequency transmissions are not significantly affected by the presence of steel structures, and do not need large antennas, and provide higher data transfer rates compared with lower frequency systems. Microwave frequency transmissions are somewhat more susceptible to performance degradation due to the presence of metals and liquids than are UHF, and are also directional. The preferred operating frequency in Europe and the UK would be a frequency in the UHF range, 868-870 MHz, as this provides a good balance between range and performance, and is not likely to suffer from interference. The data is preferably transmitted by frequency modulation.

The calculating means must take into account the cyclic loads or vibration to which the item has been subjected and the frequency response transfer function for any other item mounted to it. Such calculations are represented in terms of a Fatigue Damage Spectrum, where the damage dosage is expressed over a range of component natural frequencies; or a discrete damage sum for each particular component mounted to the item. The analysis proceeds by convolving the measured input acceleration through a series of frequency transfer functions pertaining to each natural frequency and then assessing the damage dosage using a process of “rainflow cycle counting” and damage summation. In practice the vibrations are not usually of constant amplitude or frequency, and the loads may not return to zero, so that the calculations should take into account both the “closed loops” (where the vibration returns to the unloaded state) and also “open loops” (where the vibration does not return to the unloaded state). Such calculations may be referred to as “fatigue damage dosage”.

Estimating the remaining service life of a vehicle or component is typically undertaken by deciding on a proxy measure that is indicative of consumed life. In a road vehicle the mileage odometer reading is typically used. In farm and construction vehicles engine hours are considered to be more representative of actual life consumed. In the military environments efforts have been made to characterise consumed life based on mission profile types. For example the length of time a vehicle spends on different terrains is measured in an effort to understand the damage to the vehicle, as 10 miles of on-road driving is much less damaging than 10 miles of off-road driving. This technique is known as Terrain Sensing.

The traditional Terrain Sensing System measures acceleration levels on the un-sprung suspension components of a ground vehicle and creates a cumulative count of the vibration intensity in a number of severity bands. Terrain severity is usually classified in qualitative terms such as off-road, rough-road, town-road, smooth-road, and vehicle idle.

The Damage Dosing System described in this specification uses proven calculating methodologies to record terrain severity in quantitative terms that are proportional to the actual fatigue damage contributed by varying usage. By measuring acceleration or load on the sprung mass, rather than the unsprung mass, this analysis uses the Shock Response Spectrum (SRS), devised by the American engineer Biot in 1934, along with an analogous Fatigue Damage Spectrum (FDS) developed by the French Ministry of Defence through the 1980's, to assess the cumulative damage seen by the vehicle and its onboard equipment, both mechanical and electronic. The calculating methodology has been described in the French Military design standard GAM EG-13 and the proposed NATO standard NATO AECTP 200.

A key part of the Damage Dosing System is the calculation methodology used to derive a value for a consumed life from the usage. The usage parameters, described in the previous paragraph, need to be calibrated against consumed life. This is similar for each of the three main areas of concern on a vehicle: the powertrain, body mounted electronics and structure.

Fatigue occurs through long-term exposure to time varying loads which although modest in amplitude give rise to microscopic cracks that steadily propagate to failure. Typically a SN curve is used to estimate the number of cycles (N) required for an item to fail when subjected to a period of constant amplitude sinusoidal stress loading (S). Unfortunately the real vibration environment for most components is not sinusoidal and is far more random in nature. A process called ‘rainflow cycle counting’ is used to extract the damaging cycles from the random stress/time history. The resultant ‘rainflow matrix’ therefore offers a reduced format for storing damage cycles which can reside in a small amount of computer memory whilst still quantifying the cumulative fatigue effect. Over a discrete period of time some of the stress cycles will not ‘close’ so the device maintains an account of open cycles that might be closed later in the service of the item. If the properties of the SN curve are known, the damage dosage of the randomly varying stresses can be determined as a single cumulative number which increases over time and is dependent on the severity of the loads in a manner proportional to the actual fatigue damage.

The rainflow-counting algorithm, also known as the “rain-flow counting method”, as is known, is used in the analysis of fatigue data in order to reduce a spectrum of varying stress into a set of simple stress reversals. It allows the application of Miner's rule in order to assess the fatigue life of a structure subject to complex loading. The algorithm was developed by Tatsuo Endo and M. Matsuiski in 1968; and Downing and Socie created one of the more widely utilised rainflow cycle-counting algorithms in 1982 (International Journal of Fatigue, Volume 4, Issue 1, January, 31-40), which was included in ASTM E 1049-85.

Although fatigue damage is attributed to stress cycles, both the amplitude and frequency of the vibrations are important. This is because the local stress at the point of failure in the item will depend on the amplitude of the input vibration and the frequency response (natural frequencies) of the item. The Damage Dosing System calculation methodology measures the input accelerations and convolves these with the frequency response to determine a representative stress at the failure point. This is then rainflow cycle counted and the damage determined as described above. Where the actual frequency response is not known, the Damage Dosing System assumes a single degree of freedom response over a range of natural frequencies and determines the damage content at each frequency band. This calculation is based on the Fatigue Damage Spectrum (FDS) approach discussed in the military design standards mentioned earlier. This approach provides the potential damage for any item fixed to the monitored platform or bracket and seeing the same vibration environment using a single cumulative matrix which is conveniently stored in a very small area of computer memory.

The damage dosage value increases with the accumulation of fatigue damage on the item. At some damage dosage value, failure will be noted in the item and this is the calibrated failure point. Failure calibration can be carried out during the initial component design phase, or during the component validation and testing phase, or through observed failures in-service. Fatigue failure is highly statistical in nature so rather than offering a discrete failed/not-failed result, the damage dosage system is also capable of offering a reliability parameter (or probability of failure). This approach to calibration also means that the exact nature and location of failures in an item need not be known prior to deployment as calibration can be conducted even after long periods of service.

The Damage Dosing System calculation methodology simplifies the complex rainflow curve (with four dimensions: stress range, mean stress, cycle count and frequency) and converts this to a ‘damage’ vector—the relative damage at each frequency.

By way of example, used within a Health Usage and Monitoring process, information derived from the damage dosing monitors can be calibrated to represent directly the residual life of military vehicle equipment such as electronic control systems, instrumentation, radios, brackets, refrigeration plant, optical and weapons systems, etc; thus enabling field staff to rapidly prioritise vehicles for deployment, increase their operational effectiveness, and improve through-life management of the fleet using Condition Based Maintenance (CBM) and Reliability Centred Maintenance (RCM) programmes.

The invention will now be further and more particularly described, by way of example only, and with reference to the accompanying drawings, in which:

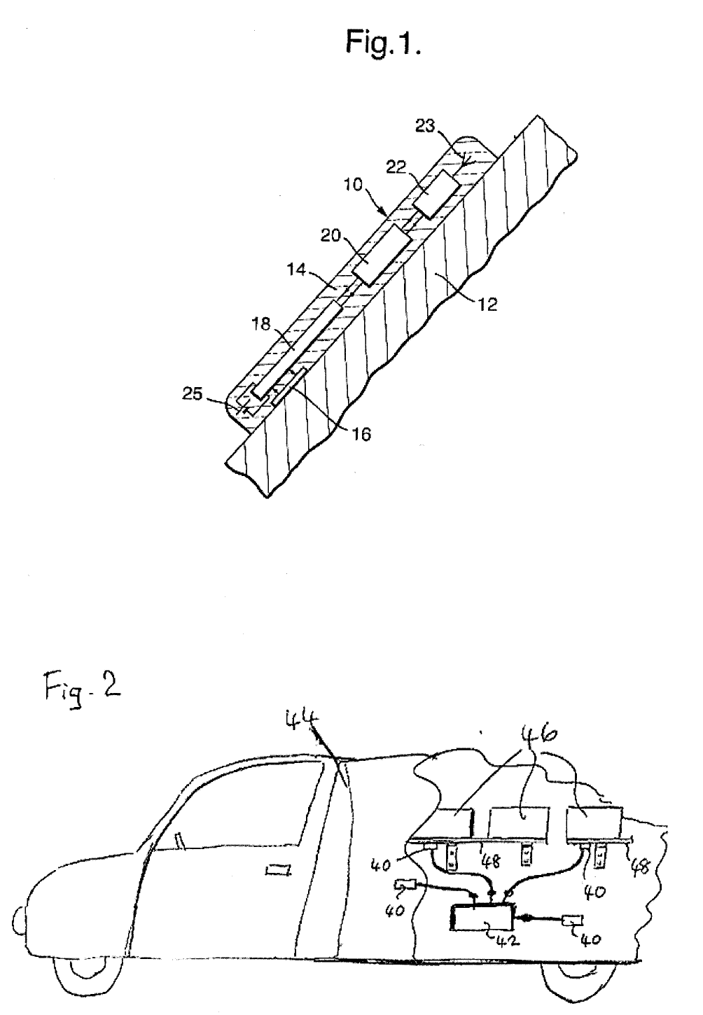

FIG. 1 shows a diagrammatic view of an electronic tag fixed on to a mechanical item; and

FIG. 2 shows a diagrammatic view of a system using a plurality of electronic tags.

Referring now to FIG. 1, an electronic tag 10 is securely fixed using an epoxy adhesive on to a steel plate 12 which forms part of a bracket supporting a vehicle radio (not shown). The overall size of the tag 10 may be, by way of example, 5 mm thick, of generally rectangular shape in plan, say 45 mm by 20 mm; the tag 10 incorporates electronic components (described below) embedded in polymeric material 14. The tag 10 incorporates an accelerometer 16 connected to a microcomputer chip 18 arranged to calculate a parameter indicative of damage; the chip 18 is connected to a memory device 20 (which will store data even when there is no electrical power available), and the memory device 20 is connected to a data transmission device 22 incorporating an aerial 23. These electronic devices are all powered by a battery 25.

Preferably the tag 10 also includes a vibration-energised generator (not shown), or a photovoltaic diode or solar cell (not shown) on the top surface of the tag 10, to ensure the battery 25 remains charged. Alternatively the battery 25 may be of sufficient capacity to last the expected life of the radio, or the battery 25 may be replaceable or rechargeable in situ by other means.

The tag 10 is securely fixed on to the radio mounting plate 12. If the radio is installed in a vehicle, it experiences varying loads, and these are monitored by the varying signals from the accelerometer 16. The microcomputer chip 18 is programmed to perform fatigue damage dosage analysis on the data representing the varying loads, determining the number of vibration cycles at different amplitudes, taking into account the presence of both open and closed vibration loops, and from the numbers of cycles of different amplitudes and frequencies deducing a parameter indicative of the damage that those vibration cycles can be expected to have caused on all items fixed to the bracket of which the plate 12 is a part. The memory 20 is updated so that it always records of the value of the damage dosage parameters. The calculation method is based on GAM EG-13 and the proposed NATO standard NATO AECTP 200, but this approach has been modified as the standards are for use in laboratory testing environments, not in operational monitoring.

At any stage the damage caused to the plate 12 and any mechanical or electronic item fixed to it can be monitored by means of a transmitter/receiver unit (not shown), this causing the data transmission device 22 to download the current value of the damage dosage parameters as recorded by the memory 20, and to transmit this via the aerial 23 to the transmitter/receiver unit. By way of example this may operate at 868-870 MHz in the UHF range. From the value of the damage dosage parameter for an item you can estimate the time before fatigue-induced failure of that item is likely to occur.

If the radio (and so the plate 12) is then removed from the vehicle, the memory 20 will continue to record the damage accumulated as a result of its use up to that point. And if the radio is subsequently reinstalled in a vehicle, the tag 10 will then continue to monitor and update the value of the damage parameter recorded by the memory 20.

It will be appreciated that a tag of the invention may be used in a wide variety of different situations, and that the tag itself may differ from that described above. For example, although use of an accelerometer within the tag is a preferred approach, alternatively the load on the item to which the tag is attached may be measured in a different manner, for example by directly measuring the strain in an item. The spectrum of load variations on the item may be measured directly, or alternatively may be calculated using a transfer function from known loads input into the item. The tag of the invention may be attached to a component of an engine or other components of a vehicle, or to a component of an aircraft, or of a turbine, or to structural components for example of a wind turbine or of an oil production platform. The only proviso is that the tag itself must not have a detrimental effect on the operation of the item or component to which it is attached. It is preferably attached and fixed to the item or component in a substantially permanent fashion, so that it will not be removed unintentionally, and the use of an adhesive for this purpose is desirable. Other means of attachment can also be envisaged, for example the tag itself might be attached to the item or component by screws, by rivets, or by welding.

The tag is desirably such that the mechanical or electronic item or component operates in exactly the same way as in the absence of the tag, and the tag does not have to be protected from the environment to which the mechanical item or component is subjected. Embedding the electronic components within polymeric material 14 is one way in which this can be ensured; alternatively the electronic components might be within a sealed casing. In the embodiment shown, the tag 10 is attached to an outside surface of the plate 12, but it will be appreciated that there may be situations in which the tag 10 may be installed in a recess in an item or a component, so that it does not protrude.

A significant benefit of the use of such a tag is that an operator can quickly assess the actual damage to a used component in the field, as well as the relative damage between components and systems. There is no necessity to remove the component from where it is in use, for laboratory analysis. The accumulated effect of all the use to which the item has been subjected, since the tag was attached to it, is summarised by the value of the damage dosage parameter recorded in the memory 20, and this information remains attached to the item even if the item itself is transferred from vehicle to vehicle, say, or is temporarily removed and subsequently replaced.

FIG. 2 illustrates an array of tags 40 linked to a central processing computing device 42. The tags 40 and the device 42 are installed in a vehicle 44 which contains electronic equipment 46, and some of the tags 40 are attached to shelves 48 supporting the equipment 46. This method of deployment allows tags 40 with accelerometers to be deployed around a vehicle, for example, with power and analysis being supplied and undertaken by the computing device 42. Preferably the tags 40 also incorporate a memory to record the calculated damage parameter.

It will be appreciated that the present invention is applicable to various applications, particularly being suitable for military ground vehicles that have springs, the accelerometer sensors being mounted on the sprung body, and the terrain severity being recorded in quantitative terms proportional to the actual fatigue damage contributed by the use to which the vehicle is subjected, and the recorded data indicating the accumulated fatigue damage, considering all frequencies.

We claim:

1. An electronic tag to be fixed on to or near to a mechanical or electronic system, the electronic tag comprising at least one sensor in the form of an accelerometer or strain gauge, means to provide signals from each sensor to a calculating means arranged to calculate the resulting damage, the tag also comprising a memory to record data representing the resulting and relative damage, and means to enable the recorded data to be read.

2. A tag as claimed in claim 1 wherein the calculating means is within the tag.

3. A tag as claimed in claim 1 also incorporating a battery, and means to generate electricity.

4. A tag as claimed in claim 1 wherein the means to read the recorded data includes an aerial for radio transmission and downloading of the data.

5. A tag as claimed in claim 4 wherein the recorded data is transmitted from the aerial by frequency modulation.

6. A tag as claimed in claim 1 wherein the calculating means takes into account both closed loops and open loops in calculating the resulting damage.

7. A tag as claimed in claim 1 wherein the calculating means takes into account the damage to any other item attached to the monitored item.

8. A network of tags as claimed in claim 1 powered by and linked to a central computing node that undertakes damage dosing calculations.

9. A method of monitoring damage suffered by a mechanical or electronic item by use of a tag as claimed in claim 1.

10. A method as claimed in claim 9 wherein the tag is fixed to the item by an adhesive.

11. A method as claimed in claim 9 wherein the calculating methodology is based on French Military design standard GAM EG-13 and the proposed NATO standard NATO AECTP 200.

12. A method as claimed in claim 9 wherein the calculating methodology correlates usage with damage via the reduction of random vibration input through convolution with a specific frequency response function or a range of single degree of freedom responses over a range of natural frequencies; through rainflow cycle counting; and through a representative SN curve, to a single parameter representative of damage accumulation with usage.

13. A method as claimed in claim 9 wherein the calculation and display of relative damage (in terms of estimated life) is performed for a plurality of items each subject to the same vibrations as the tag, the relative damage of components or systems of items not directly attached to the tag being calculated by means of a transfer function, and wherein the nominal expected life is determined by historical failure information or design studies, and is modified as the failure history of components is accumulated.
